(19) United States
(12) Patent Application Publication
(10) Pub. No.: US 2022/0100788 A1
(43) Pub. Date: Mar. 31, 2022

(54) METHOD OF PRESENTING MULTIMEDIA CONTENT WITH THIRD PARTY CONTROL

(71) Applicant: Charles Lap San CHAN, Taipei (TW)

(72) Inventor: Charles Lap San CHAN, Taipei (TW)

(21) Appl. No.: 17/495,510

(22) Filed: Oct. 6, 2021

(30) Foreign Application Priority Data
Sep. 28, 2020 (TW) 109133618

(51) Int. Cl. G06F 16/438; G06F 16/41; G06F 16/435

(52) U.S. Cl. CPC G06F 16/438; G06F 16/435; G06F 16/41

(57) ABSTRACT

The present invention provides a method of presenting multimedia content with third party control, which can specify different multimedia content providing devices to provide different types of multimedia content data, and also can specify different multimedia content presenting devices to present different multimedia content data. In the present invention, the multimedia content data provided by the multimedia content providing device can also be transmitted to the multimedia content presenting device after being further processed. The present invention can be applied to use situations including transmission and presentation of the multimedia content data such as video conferencing, voice conferencing, advertising, online broadcasting and sound broadcasting.

This application claims priority of Application No. 109133618 filed in Taiwan on 28 Sep. 2020 under 35 U.S.C. § 119; the entire contents of all of which are hereby incorporated by reference.

### BACKGROUND OF THE INVENTION

### Field of the Invention

The present invention relates to a method of presenting multimedia content with third party control, in particular, a method of presenting multimedia content data of different sources onto different multimedia content presenting devices.

### Description of the Prior Art

With the increasing development of network speed and bandwidth, more and more electronic devices are configured to have the function of accessing the Internet, which can provide multimedia content data to specific objects or destinations through the network. Commonly, the multimedia content data provided by this kind of electronic devices, for example, include images, pictures, sounds, text, etc., and cover street view images, video call images, images and pictures of surveillance cameras, the sound of network microphones, broadcast sounds of network radios, data text provided by temperature/humidity sensors, and more.

This kind of electronic devices also has a low price due to the maturity of production technology and the decline of manufacturing costs, so as to be increasingly purchased and used by corporate or individual consumers. When a large number of electronic devices that can access the Internet and provide multimedia content data are configured, in addition to the original applications, whether other use situations can be developed and the scope of application can be extended is a direction worthy of the efforts of those skilled in the art.

### SUMMARY OF THE INVENTION

A major objective of the present invention is to provide a method of presenting multimedia content with third party control, which may present multimedia content data of different sources onto different multimedia content presenting devices.

Another objective of the present invention is to provide a method of presenting multimedia content with third party control, which may combine the multimedia content data of different sources into different layout patterns for outputting to the multimedia content presenting device.

Another objective of the present invention is to provide a method of presenting multimedia content with third party control, which may be applied to use situations including transmission and presentation of the multimedia content data such as video conferencing, voice conferencing, advertising, online broadcasting and sound broadcasting.

To achieve the above objectives, the present invention provides a method of present multimedia content with third party control, which is operated in an environment where a multimedia content processing platform is connected to a plurality of multimedia content devices, and includes steps of:

(A) one of the plurality of multimedia content devices is operated as a control panel device;
(B) at least two of the plurality of multimedia content devices are configured as multimedia content providing devices;
(C) different multimedia content data, by the multimedia content providing devices, are transmitted to the multimedia content processing platform;
(D) at least two of the plurality of multimedia content devices are configured as multimedia content presenting devices;
(E) the control panel device controls a processing way the multimedia content processing platform processes the multimedia content data; and
(F) the control panel device controls a transmitting way the multimedia content processing platform transmits the multimedia content data to the multimedia content presenting device, wherein the transmitting way at least includes transmitting the different multimedia content data to the different multimedia content presenting devices.

The characteristics, advantages, or similar expressions mentioned in the specification do not imply that all features and advantages that may be realized by the present invention shall be contained in any single specific embodiment of the present invention. It should be understood, however, that the expression of the characteristics and advantages refers to the combination of specific characteristics, advantages, or characteristics described in the specific embodiments are included in at least one specific embodiment of the present invention. Therefore, the discussion of features and advantages and similar expressions in the specification relates to, but is not necessary, the same specific embodiment.

These characteristics and advantages of the present invention can be further illustrated by referring to the following instructions and the accompanying scope of patent application or by using the embodiment of the present invention as mentioned below.

### BRIEF DESCRIPTION OF THE DRAWINGS

FIG. 1 shows a system of controlling the multimedia content by a third party to present according to a preferable embodiment.

FIG. 2 shows a flow chart of controlling the multimedia content by a third party to present according to a preferable embodiment.

FIG. 3 shows a view of a user control interface according to a preferable embodiment.

### DESCRIPTION OF THE PREFERRED EMBODIMENTS

In order to make the narrative of the present disclosure more detailed and complete, the following is a descriptive description of the embodiment and specific embodiments of the present invention, but this is not the only form of implementation or application of the specific embodiment of the present invention. The embodiment covers the characteristics of several specific embodiments and the method steps and sequence used to construct and operate these specific embodiments. However, other specific embodiments may also be used to achieve the same or equal function and step sequence.

The present invention provides a method of presenting multimedia content with third party control, which may present multimedia content data of different sources onto different multimedia content presenting devices. Further, the method of the present invention may combine the multimedia content data of different sources into different layout patterns for outputting to the multimedia content presenting device. The method of the present invention may be applied to use situations including transmission and presentation of the multimedia content data such as video conferencing, voice conferencing, advertising, online broadcasting and sound broadcasting.

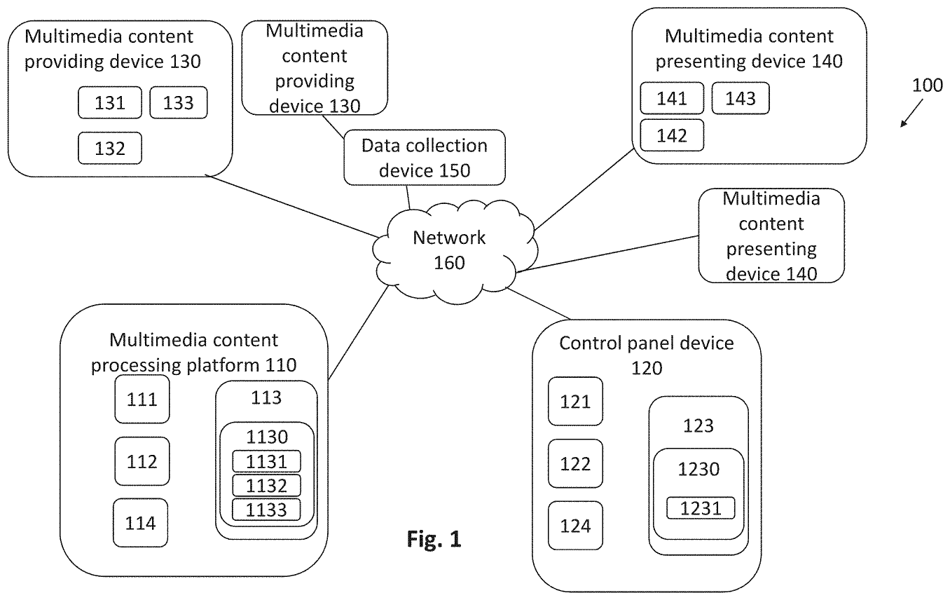

With reference to FIG. 1, a system 100 that may control the multimedia content to present by a third party according to a preferable embodiment is shown, wherein the system 100 includes a multimedia content processing platform 110 and a plurality of multimedia content devices, and the multimedia content devices may be classified into a control panel device 120, a multimedia content providing device 130 and a multimedia content presenting device 140 according to the functions. In addition, in order to help the multimedia content providing device 130 that cannot transmit the multimedia content data generated therefrom to the multimedia content processing platform 110, the system 100 may further selectively include a data collection device 150, and the data collection device 150 may receive the multimedia content data provided by the multimedia content providing device 130 via the entity online, which are transmitted to the multimedia content processing platform 110 via a network 160. The multimedia content processing platform 110, the multimedia content devices and the data collection device 150 in the system 100 may be connected to each other via the network 160. The network 160 may include a wide area network (WAN, “Wide area network”), such as the Internet, a local area network (LAN), a campus local area network, a metropolitan local area network, or any other network that allows data communication.

In an embodiment of the present invention, the multimedia content processing platform 110 has a data processing unit 111, a network communication interface 112, a memory unit 113 and a storage unit 114, and the memory unit 113 is stored with software program codes of an application 1130, wherein the application 1130 includes a device management module 1131, a multimedia content processing module 1132 and an account management module 1133. The control panel device 120 has a data processing unit 121, a network communication interface 122, a memory unit 123 and a user input/output interface 124, and the memory unit 123 is stored with software program codes of an application 1230, wherein the application 1230 includes a user control interface 1231.

The multimedia content providing device 130 has a data processing unit 131, a network communication interface 132 and a multimedia content data generating unit 133. The multimedia content presenting device 140 has a data processing unit 141, a network communication interface 142 and a multimedia content data presenting unit 143. It should be understood that in the embodiment of the present invention, the multimedia content device may be an electronic device including multiple function units or function modules such as a laptop computer with the data processing unit, the network communication interface, the memory unit, the storage unit, the user input/output interface, the multimedia content data generating unit, the multimedia content data presenting unit and so on; functionally, it may function as the control panel device 120, the multimedia providing device 130, or the multimedia presenting device 140; however, in an embodiment, it is only used as the multimedia content providing device, so it uses only the data processing unit, the network communication interface, and the multimedia content data generating unit as the functions; or in another embodiment, it is only used as the multimedia content presenting device, so it only uses the data processing unit, the network communication interface, and the multimedia content data presenting unit.

The multimedia content processing platform 110 may be arranged on a computer (not shown), or may be arranged on multiple computers to provide more powerful computing and processing performance. The data processing unit 111 of the multimedia content processing platform 110 may be a central processing unit (CPU), a multi-processor, a distributed processing system, an application specific integrated circuit (ASIC), and/or a suitable processing unit. The data processing unit 111 is configured to execute instructions for realizing functions of the multimedia content processing platform 110.

The network communication interface 112 may be a wireless transceiver unit that supports wireless communication standards such as Institute of Electrical and Electronics Engineers (IEEE) 802.11n/b/g, which can wirelessly link to other external devices. In addition, the network communication interface 112 may also include protocols such as third generation mobile communications (3G) modules, long-term evolution (LTE) network communication interfaces, Wi-Fi modules, or Bluetooth, which can wirelessly link to other external devices. For example, the network communication interface 112 may have antenna and other wireless transceiver units. Further, the network communication interface 112 may also support wired networks, such as a network card, which is not limited thereto. The network communication interface 112 is used to receive data from and transmit data to other devices in the system 100 through the network.

The memory unit 113 and the storage unit 114 may be electronic, magnetic, optical, electromagnetic, infrared, and/or semiconductor systems (or devices or components). For example, semiconductor or solid state memory, tape, removable computer disks, random access memory (RAM), read-only memory (ROM), hard drives, and/or optical discs are included. In some certain embodiments, the memory unit 113 stores the application 1130 containing executable instructions, and the data processing unit 111 executes the instructions in the application 1130 to implement the operation of the device management module 1131, the multimedia content processing module 1132 and the account management module 1133. In addition, although the application 1130 including the device management module 1131, the multimedia content processing module 1132 and the account management module 1133 is stored in the memory unit 113, in another embodiment, the software program codes of the application 1130 may be stored in the storage unit 114 and loaded into the memory unit 113 when the device management module 1131, the multimedia content processing module 1132 or the account management module 1133 is required to be operated.

The device management module 1131 is applied to the management of the multimedia content device and the data collection device 150, i.e., including such as the control panel device 120, the multimedia content providing device 130, the multimedia content presenting device 140 and the data collection device 150. The device management module 1131 establishes a device list when the above devices are connected to the network 160, and the device list collects and records the information of each multimedia content device and the data collection device 150, including such as categories, features and specifications, which is not limited in the present invention. The category is used to indicate the role of the multimedia content device in system 100, and the category may be marked as the control panel device, the multimedia content providing device, the multimedia content presenting device or the data collection device. The feature is used to indicate what the multimedia content data the multimedia content device may provide in the system 100, or what the multimedia content data may be used to present; for example, the feature may be marked as images, sounds, pictures, or text, etc., or can be used to present images, sounds, pictures, or text, and so on. The specification is used to indicate the hardware specification of the multimedia content device; for example, if the multimedia content device is a digital television, the specification may indicate the resolution; if the multimedia content device is an intelligent digital television, the specification may indicate the resolution, the operating system, the processor, etc.; if the multimedia content device is a smart digital speaker, the specification may indicate the operating system, the processor, the horn power and so on.

The multimedia content processing module 1132 may decide a processing way for the received multimedia content data according to the processing instructions issued by the user operating the control panel unit 120. In an embodiment of the present invention, the processing way includes, but is not limited to combining a plurality of image data into one integrated image data, combining image data and sound data into one integrated audio and video data, processing a plurality of picture data with text data to produce effects such as movie playback, scrolling through the text data as a running light, changing the file format of the multimedia content data, different output layouts after the combination of the multimedia content data, adjusting the resolution of the multimedia content data according to the resolution of the multimedia content present device 140, and so on. Moreover, the processing way of the multimedia content data may further decided according to the type, weight, or real-time nature of the multimedia content data, e.g., according to different types of image data, sound data, text data that are in large, medium and small proportions in the output layout. For example, there are more than one image data, then the weight of the larger proportion in the output layout is larger; for example, if there is more than one image data, the higher real-time in the output layout of a larger proportion, or when the combination of the plurality of image data should be displayed in sequence, the image data with the higher real-time nature is displayed first. It should be understood that the present invention is not limited to the above descriptions.

In other embodiments of the present invention, each multimedia content presenting device 140 may also be selectively configured with the multimedia content processing module (not shown) to process the multimedia content data, so that the workload of the multimedia content processing platform 110 may be greatly reduced. For example, when a user operates the control panel device 120 to issue processing instructions for the multimedia content data and also specifies the corresponding multimedia content presenting device 140, the user may also operate the control panel device 120 to specify a multimedia content processing module of this multimedia content presenting device 140 for processing the multimedia content data and presenting the multimedia content data on this multimedia content presenting device 140 if the device list shows that the multimedia content presenting device 140 has the multimedia content processing module (not shown).

The account management module 1133 may be used to store a user account and data such as account permissions corresponding to the user account, and the contents of the above device list accessed by different account permissions are different. The user account may be, for example, classified into a manager account, a normal account, or a temporary account and so on. The account permission may include, but not limited to, the multimedia content providing devices 130 that may be controlled, the multimedia content presenting devices 140 that may be controlled, a time interval that may be controlled, a time length that may be controlled, or a region area that may be controlled. The time interval can be, for example, 8 a.m. to 2 p.m.; the time length can be, for example, 4 hours; the regional area may, for example, be a multimedia content device owned by an enterprise in a Taipei office, which are not limited therein.

The storage unit 114 may be used to store the multimedia content data transmitted from each multimedia content providing device 130, so that the user may also access the previous multimedia content data and provide the previous multimedia content data to the multimedia content presenting device 140 for presentation. In other embodiments of the present invention, each multimedia content providing device 130 may further selectively be configured with a storage unit (not shown) to store the multimedia content data, and then the user may also obtain the previous multimedia content data from the storage unit in the multimedia content providing device 130 and provide the multimedia content data to the multimedia content presenting device 140 for presentation.

The data processing unit 131 of the multimedia content providing device 130, the data processing unit 141 of the multimedia content presenting device 140, and the data processing unit 121 of the control panel device 120 may be described with reference to the data processing unit 111 of the multimedia processing platform 110, which will not be repeated herein. The network communication interface 132 of the multimedia content providing device 130, the network communication interface 142 of the multimedia content presenting device 140, and the network communication interface 122 of the control panel device 120 may also be described with reference to the network communication interface 112 of the multimedia processing platform 110, which will not be repeated herein.

The multimedia content data generating unit 133 of the multimedia content providing device 130 is configured to generate the multimedia content data, by, for example, but not limited to, generating pictures with a camera unit, generating image data with a recording unit, generating sound data with a microphone, generating temperature text data with a temperature sensor, or generating humidity text data with a humidity sensor, and so on.

The multimedia content data presenting unit 143 of the multimedia content presenting device 140 is configured to present the multimedia content data, by, for example, but not limited to, presenting pictures, images or text data with a display unit, presenting sound data with a speaker, presenting temperature text data or humidity text data with an electronic bulletin board, and so on.

The memory unit 123 of the control panel device 120 may also be described with reference to the memory unit 113 of the multimedia content processing platform 110. In some embodiments, the memory unit 123 is stored with an application 1230, and the application 1230 includes executable instructions, which are executed by the data processing unit 121 of the control panel device 120 to realize operations such as the user control interface 1231. However, in some other embodiments, software program codes of the application 1230 may be stored in the storage unit (not shown) of the control panel device 120, and loaded into the memory unit 123 when the operations of the user control interface 1231 is to be executed. The user control interface 1231 is configured to control the multimedia content providing device 130 in the device list for providing the multimedia content data to the multimedia content processing platform 110 according to the account permissions and the content of the device list corresponding to the account permissions after the user account logs in, to process the multimedia content data according to a processing way specified by the user, and finally to transmit the multimedia content data to the multimedia content presenting device 140 according the processing way specified by the user, wherein the processing way includes, but not limited to, transmitting different multimedia content data to different multimedia content presenting devices 140, transmitting one of the multimedia content data to all or part of the multimedia content presenting devices 140, and combining different multimedia content data into an integrated multimedia content data and transmitting it to all or part of the multimedia content presenting devices 140.

The user input/output interface 124 of the control panel device 120 may include a keyboard, a mouse, a display and an audio/video equipment such as a camera and a microphone; the user input/output interface 124 may display the user control interface 1231 for the user to watch and may be operated to issue instructions to the control panel device 120. For example, the keyboard and the mouse provide an input device, allowing the user to manipulate the control interface 1231 on the display for issuing instructions to the control panel device 120. Of course, depending on how the above operation is implemented, the user input/output interface 124 may further include other devices (not shown), such as speech recognition software, touch screen or tablet computer, handwriting recognition, and so on.

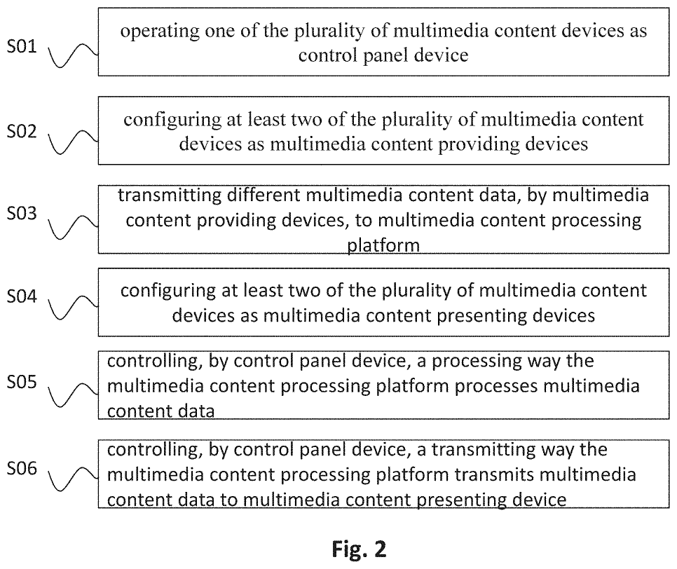

FIG. 2 shows a flow chart of controlling the multimedia content by a third party to present according to a preferable embodiment. The following descriptions refer to the FIGS. 1 and 2. First, in step S01, the user operates a certain multimedia content device in the system 100 as the control panel device 120. The step S01 further includes: a user account is pre-configured in the account management module 1133 of the multimedia content processing platform 110 and the account permissions of the user account are configured; then, when the user operates the control panel device 120 to issue a log-in request, the device management module 1131 of the multimedia content processing platform 110 provides the content of the device list corresponding to the account permissions of the user account after the user account of the multimedia content processing platform 110 logs in. In the step S02, the user operates the user control interface 1231 to issue configuration instructions via the user input/output interface 124 for configuring at least two multimedia content devices in the device list as the multimedia content providing device 130.

In the step S03, according to the configuration instructions of the user, the multimedia content generating unit 133 of the two multimedia content providing devices 130 transmits different multimedia content data to the multimedia content processing platform 110. For example, in an embodiment, the two multimedia content providing devices 130 may provide different image data respectively; in another embodiment, the two multimedia content providing devices 130 may provide image data and sound data respectively, which are not limited herein. In other embodiments of the present invention, since the multimedia content providing device 130 may have simple functions and cannot access to the Internet, the multimedia content providing device 130 will first transmit the multimedia content data online through the entity to a data collection device 150, and then the data collection device 150 transmits the multimedia content data to the multimedia content processing platform 110 via the network 160.

Further, if the storage unit 114 of the multimedia content processing platform 110 is stored with the multimedia content data previously transmitted from each multimedia content providing device 130 or the multimedia content providing device 130 has been configured with the storage unit (not shown) and is stored with the previous multimedia content data, the configuration instructions may be: the multimedia content data generating unit 133 of the multimedia content providing device 130 providing real-time multimedia content data, the storage unit 114 of the multimedia content processing platform 110 providing previously-stored multimedia content data, or the storage unit (not shown) of the multimedia content providing device 130 providing previously-stored multimedia content data, or the combinations thereof, which are not limited herein.

In the step S04, the user operates the user control interface 1231 to issue another configuration instruction again via the user input/output interface 124 for configuring at least two multimedia content devices as the multimedia content presenting device 140. The multimedia content presenting device 140 presents the multimedia content data with the multimedia content data presenting unit 143. For example, in an embodiment, the two multimedia content presenting devices 140 may be a television and a laptop respectively; in another embodiment, the two multimedia content presenting devices 140 may be a smart speaker and a laptop respectively.

In the step S05, the user operates the user control interface 1231 of the control panel device 120 to issue processing instructions for controlling a processing way of the multimedia content processing platform 110 for the multimedia content data, wherein as mentioned above, the processing way may include, but is not limited to combining a plurality of image data into one integrated image data, combining image data and sound data into one integrated audio and video data, processing a plurality of picture data with text data to produce effects such as movie playback, scrolling through the text data as a running light, changing the file format of the multimedia content data, different output layouts after the combination of the multimedia content data, and adjusting the resolution of the multimedia content data according to the resolution of the multimedia content present device 140. Moreover, the processing way for the multimedia content data may further be decided according to the type, weight, or real-time nature of the multimedia content data. For instance, the processing way for the multimedia content data may be decided: according to different types of image data, sound data, text data that are in large, medium and small proportions in the output layout; according to a situation that there are more than one image data, then the weight of the larger proportion in the output layout is larger; according to a situation that if there is more than one image data, the higher real-time in the output layout of a larger proportion, or when the combination of the plurality of image data should be displayed in sequence, the image data with the higher real-time nature is displayed first. It should be understood that the present invention is not limited to the above descriptions.

In addition, as mentioned above, the multimedia content presenting device 140 may also be selectively configured with the multimedia content processing module (not shown) to process the multimedia content data, so that the workload of the multimedia content processing platform 110 may be reduced. Therefore, a certain multimedia content present device 140 configured as the multimedia content presenting devices 140 is found when a user operates the control panel device 120, the user may, if the device list shows that the multimedia content presenting device has the multimedia content processing module (not shown), also operate the processing instructions transmitted by the user control interface 1231 to specify the multimedia content processing module of this multimedia content presenting device 140 for processing the multimedia content data and presenting the multimedia content data.

In the step S06, the user operates the user control interface 1231 of the control panel device 120 to send transmitting instructions, which control a transmitting way the multimedia content processing platform 110 transmits the multimedia content data to the multimedia content presenting device 140, wherein the transmitting way includes, but not limited to, transmitting different multimedia content data to different multimedia content presenting devices 140, transmitting one of the multimedia content data to all or part of the multimedia content presenting devices 140, and combining different multimedia content data into an integrated multimedia content data and transmitting it to all or part of the multimedia content presenting devices 140.

It should be understood that in an embodiment of the present invention, the multimedia content providing device 130 may be different from the multimedia content presenting device 140, as shown by an example in FIG. 1. However, in other embodiments, a part of the multimedia content providing device 130 and a part of the multimedia content presenting device 140 may be the same multimedia content device; for example, a laptop functions as the multimedia content providing device 130 to provide the multimedia content data the other multimedia content presenting devices 140 while the laptop functioning as the multimedia content presenting device 140 to receive the multimedia content data provided by other multimedia content providing devices 130.

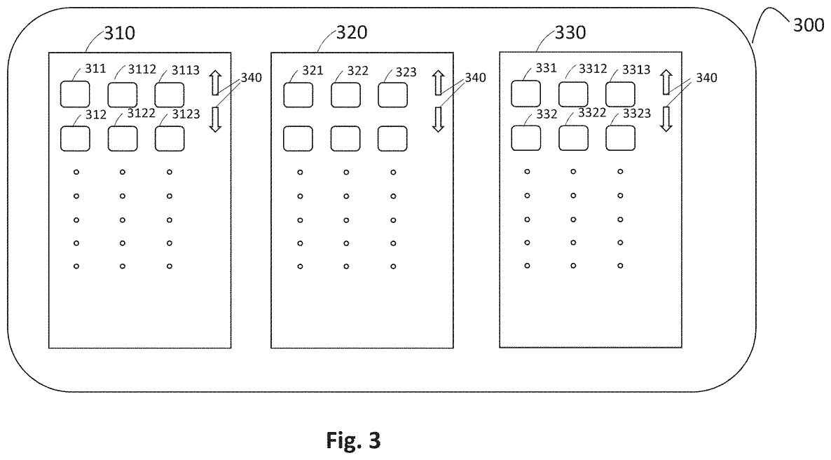

FIG. 3 shows a view of a user control interface according to a preferable embodiment. As shown in FIG. 3, the user control interface 300 includes a multimedia content providing device chunk 310, a processing method chunk 320, and a multimedia content presenting device chunk 330; if each chunk contains too many items, a roll button 340 may be used to roll up and down for showing more content. In the multimedia content providing device chunk 310, a block 311 corresponds to a first multimedia content providing device, a block 312 corresponds to a second multimedia content providing device, and blocks 311 and 312 may also display simple graphics to prompt the user what type of the multimedia content providing devices they are, such as a camera, a microphone, and so on. A block 3112 may be used to prompt the user what type of the multimedia data content the first multimedia content providing device can provide, e.g., images are displayed on the block 3112; a block 3122 may be used to prompt the user what type of the multimedia data content the second multimedia content providing device can provide, e.g., sounds are displayed on the block 3122; A block 3113 is available for the user to check; for example, when the user checks the block 3113, the user selects the first multimedia content providing device to provide the multimedia content data, e.g., the image data. A block 3123 is also available for the user to check; for example, when the user checks the block 3123, the user selects the second multimedia content providing device to provide the multimedia content data, e.g., the sound data.

Each block in the processing method chunk 320 may correspond to a processing way for the multimedia content data and is available for the user to check; for example, if a block 321 is checked, it is indicated that a plurality of image data are combined into an integrated image data; if a block 322 is checked, it is indicated that the image data are combined with the sound data to form an integrated audio-visual data; if a block 323 is checked, it is indicated that effects such as displaying and playing movie can be generated after a plurality of picture data and the text data are processed; other blocks may represent other processing ways.

In the multimedia content presenting device chunk 330, a block 331 corresponds to a first multimedia content presenting device, a block 332 corresponds to a second multimedia content presenting device, and blocks 331 and 332 may also display simple graphics to prompt the user what type of the multimedia content presenting devices they are, such as a digital TV set, a digital speaker, and so on. A block 3312 may be used to prompt the user what type of the multimedia data content the first multimedia content presenting device can present, e.g., images are displayed on the block 3312; a block 3322 may be used to prompt the user what type of the multimedia data content the second multimedia content presenting device can provide, e.g., sounds are displayed on the block 3322. A block 3313 is available for the user to check; for example, when the user checks the block 3313, the user selects the first multimedia content presenting device to present the multimedia content data, e.g., the image data. A block 3323 is also available for the user to check; for example, when the user checks the block 3323, the user selects the second multimedia content presenting device to present the multimedia content data, e.g., the sound data.

With the above example of the user control interface 300, the user can easily choose to provide a variety of different multimedia content data with the desired multimedia content providing devices, and use the user-imagined processing method to process the multimedia content data and then transmit the multimedia content data to the multimedia content presenting device for presentation. It can be understood that the user control interface 300 in FIG. 3 above is only used for exemplary instructions, and the present invention is not limited to the embodiment.

Through the above descriptions, it can be known that the present invention provides a method of presenting multimedia content with third party control, which may present multimedia content data of different sources onto different multimedia content presenting devices. Further, the method of the present invention may combine the multimedia content data of different sources into different layout patterns for outputting to the multimedia content presenting device. The method of the present invention may be applied to use situations including transmission and presentation of the multimedia content data such as video conferencing, voice conferencing, advertising, online broadcasting and sound broadcasting.

The above are only better embodiments of the present invention, not to limit the scope of implementation of the present invention. Therefore, all equal changes and modifications in shape, structure, characteristics and spirit as described in the scope of the present invention shall be included within the scope of the present invention.

What is claimed is:

1. A method of present multimedia content with third party control, operated in an environment where a multimedia content processing platform is connected to a plurality of multimedia content devices, comprising steps of:
(A) operating one of the plurality of multimedia content devices as a control panel device;
(B) configuring at least two of the plurality of multimedia content devices as multimedia content providing devices;
(C) transmitting different multimedia content data, by the multimedia content providing devices, to the multimedia content processing platform;
(D) configuring at least two of the plurality of multimedia content devices as multimedia content presenting devices;
(E) controlling, by the control panel device, a processing way the multimedia content processing platform processes the multimedia content data; and
(F) controlling, by the control panel device, a transmitting way the multimedia content processing platform transmits the multimedia content data to the multimedia content presenting device, wherein the transmitting way at least comprises transmitting the different multimedia content data to the different multimedia content presenting devices.

2. The method of present multimedia content with third party control according to claim 1, wherein the multimedia content providing devices are different from the multimedia content presenting devices.

3. The method of present multimedia content with third party control according to claim 1, wherein a part of the multimedia content providing devices and a part of the multimedia content presenting devices are the same multimedia content devices.

4. The method of present multimedia content with third party control according to claim 1, wherein the step (C) further comprises: transmitting, by the multimedia content providing devices, the different multimedia content data to a data collection device, and further transmitting, by the data collection device, the multimedia content data to the multimedia content processing platform.

5. The method of present multimedia content with third party control according to claim 1, wherein the processing way the multimedia content processing platform processes the multimedia content data comprises: combining the different multimedia content data into an integrated multimedia content data, converting the multimedia content data to conform to an output format of the multimedia content presenting devices, or deciding an output layout of the different multimedia content data after combination.

6. The method of present multimedia content with third party control according to claim 1, wherein the control panel device may decide the processing way the multimedia content processing platform processes the multimedia content data according to a type, a weight, or a real-time nature of the multimedia content data.

7. The method of present multimedia content with third party control according to claim 1, wherein the transmitting way further comprises: transmitting one of the multimedia content data to all or a part of the multimedia content presenting devices, and transmitting an integrated multimedia content data formed by combining the different multimedia content data to all or a part of the multimedia content presenting devices.

8. The method of present multimedia content with third party control according to claim 1, wherein the step (A) further comprises:
(A1) configuring a user account on the multimedia content processing platform;
(A2) configuring an account permission for the user account; and
(A3) operating the control panel device to log in the user account.

9. The method of present multimedia content with third party control according to claim 8, wherein the account permission comprises: the multimedia content providing devices that may be controlled, the multimedia content presenting devices that may be controlled, a time interval that may be controlled, a time length that may be controlled, or a region area that may be controlled.

10. The method of present multimedia content with third party control according to claim 1, wherein the multimedia content processing platform is provided with a storage unit for storing the multimedia content data.

11. The method of present multimedia content with third party control according to claim 10, wherein the control panel device may selectively control the multimedia content processing platform to transmit the multimedia content data that are received in time to the multimedia content present devices, or transmit the multimedia content data stored by the storage unit of the multimedia content processing platform to the multimedia content presenting devices.

12. The method of present multimedia content with third party control according to claim 1, wherein each of the multimedia content providing devices is provided with a corresponding storage unit for storing the multimedia content data.

13. The method of present multimedia content with third party control according to claim 12, wherein the control panel device may control the multimedia content processing platform to receive the multimedia content data stored by the storage units of the multimedia content providing devices and further transmit the multimedia content data to the multimedia content presenting devices.
